(19) United States
(12) Patent Application Publication
(10) Pub. No.: US 2007/0168902 A1
(43) Pub. Date: Jul. 19, 2007

(54) Method for high-level synthesis of semiconductor integrated circuit

(76) Inventors: Osamu Ogawa, Osaka (JP); Kentaro Shiomi, Hyogo (JP); Yusuke Nemoto, Kyoto (JP); Yuishi Torisaki, Osaka (JP)

Correspondence Address: MCDERMOTT WILL & EMERY LLP, 600 13TH STREET, N.W., WASHINGTON, DC, 20005-3096, US

(21) Appl. No.: 11/633,568

(22) Filed: Dec. 5, 2006

(30) Foreign Application Priority Data
Jan. 18, 2006 (JP) 2006-010387

(51) Int. Cl. G06F 17/50

(52) U.S. Cl. 716/18

(57) ABSTRACT

A Control Data Flow Graph (CDFG) which is an intermediate representation obtained by analyzing a behavioral-level circuit description of hardware, is subjected to a process of changing a shape of the CDFG by adding an operation before or after scheduling, so as to conceal design information. A CDFG to which a hardware resource has been allocated may be subjected to a process of changing the allocation of the hardware resource.

### BACKGROUND OF THE INVENTION

1. Field of the Invention

The present invention relates to a method for high-level design of a semiconductor integrated circuit, and more particularly, to a method for concealing design information in a circuit description.

2. Description of the Related Art

Information processing functions carried out by a single integrated circuit have been dramatically improved with the progress of semiconductor miniaturization technology and information technology. Since such an integrated circuit generally has a large scale and complexity, it is not practical to design the integrated circuit only manually. In recent years, the integrated circuit design is divided into work steps, such as functional design, logical design, physical design and the like. These work steps are aided by a software environment called Electronic Design Automation (EDA). Particularly, the functional design is abstracted. In general, a circuit description at a Register Transfer Level (RTL) is created using a programming language for hardware design called Hardware Description Language (HDL) to design a function of an integrated circuit. Further, recently, a high-level synthesis technique of automatically creating an RTL circuit description from a circuit description at a high level called a behavioral level has been employed so as to achieve more abstract high-level design.

However, whereas design efficiency is improved by hardware design at a high level or a functional level using a programming language, design data in which design is abstracted is easily decrypted by the third party when it outflows. The development process of an integrated circuit is divided into a number of tasks ranging from design to manufacture (division of labor), so that design data (circuit description) at the behavioral level or in the RTL are transferred via electronic mail or a recording medium. Therefore, design data may be subjected to a treatment for protecting the design information from others than the designer so as to reduce the risk of leakage or unauthorized use of the design information when the design data outflows.

A method has been known in which a name of a variable or the like in a circuit description indicating a circuit structure is automatically converted into another name which is not related to the circuit structure (see JP No. 2002-163312 A and JP No. 2005-235848 A). According to the method, for example, a variable name CNT indicating a counter is converted into a totally different name from which the counter is not inferred, such as N1 or the like. Since a circuit description in which a variable name is changed cannot be easily decrypted by others than the designer, the risk of unauthorized use can be reduced. Also, in a commercially available high-level synthesis tool, a variable name or the like in a behavioral-level circuit description may be inherited by a wire name or a register name in an RTL circuit description so as to increase the readability of an output RTL circuit description. Therefore, by changing a name in a behavioral-level circuit description, it is possible to reduce the risk of unauthorized use of an RTL circuit description after high-level synthesis.

However, in the case of the above-described conventional methods, there is the risk of decryption of design information from a circuit structure or a circuit behavior. For example, a circuit description may be decrypted by analysis of a circuit behavior using simulation or the like.

### SUMMARY OF THE INVENTION

An object of the present invention is to more effectively reduce the risk of unauthorized use and unauthorized decryption of design information when a circuit description outflows.

To achieve the object, in the present invention, a dummy (redundant) behavior is inserted so as to lead to concealment of design information or confusion in decryption.

Specifically, a method for high-level synthesis of a semiconductor integrated circuit according to the present invention comprises an intermediate representation generating step of analyzing a circuit description at a behavioral level of hardware to generate a Control Data Flow Graph (CDFG) composed of a Data Flow Graph (DFG) representing a flow of an operation and data appearing in the description and a Control Flow Graph (CFG) representing a flow of control of an execution sequence of the operation, a scheduling step of allocating an execution sequence of each node of the CDFG to a time (state) synchronizing with a clock, based on information about a design constraint of a desired hardware circuit and an available hardware resource, an allocation step of allocating a hardware resource for achieving a process to each node of the CDFG scheduled in the scheduling step, a circuit concealing step of changing a shape, a circuit structure, or a part of the allocation of the hardware resource with respect to the CDFG immediately after the intermediate representation generating step or after completion of the process in the scheduling step or the allocation step, so as to conceal design information (concealment of design information or difficult decryption of a circuit description), and a circuit description output step of outputting a behavioral-level or RTL circuit description and concealment decryption information, separately, as a final result.

Note that, in the high-level synthesis method of the present invention, a type and a method of an added operation may be provided as a database.

According to the high-level synthesis method of the present invention, a redundant operation for concealment of design information (concealment of design information or difficult decryption of a circuit description) is added to a CDFG obtained by analyzing a behavioral-level circuit description, thereby making it possible to reduce the risk of unauthorized use and decryption when a circuit description outflows.

### BRIEF DESCRIPTION OF THE DRAWINGS

FIG. 1 is a flowchart illustrating a method for high-level synthesis of a semiconductor integrated circuit according to a first embodiment.

FIG. 2 is a diagram illustrating a behavioral-level circuit description in the semiconductor integrated circuit high-level synthesis method of the first embodiment.

FIG. 3 is a diagram illustrating a DFG generated in an intermediate representation generating step of the semiconductor integrated circuit high-level synthesis method of the first embodiment.

FIG. 4 is a diagram illustrating a DFG scheduled in a scheduling step of the semiconductor integrated circuit high-level synthesis method of the first embodiment.

FIG. 5 is a diagram illustrating a DFG whose shape is changed in a circuit concealing step of the semiconductor integrated circuit high-level synthesis method of the first embodiment.

FIG. 6 is a diagram illustrating a DFG to which a hardware resource is allocated in an allocation step of the semiconductor integrated circuit high-level synthesis method of the first embodiment.

FIG. 7 is a diagram illustrating an RTL circuit description which has been subjected to a concealment process and output in a circuit description output step of the semiconductor integrated circuit high-level synthesis method of the first embodiment.

FIG. 8 is a diagram illustrating an RTL circuit description which has not been subjected to a concealment process.

FIG. 9 is a diagram illustrating an upper hierarchical layer circuit description output as concealed decryption information in a circuit description output step of the semiconductor integrated circuit high-level synthesis method of the first embodiment.

FIG. 10 is a diagram illustrating a behavioral-level circuit description which has been subjected to a concealment process and output in the circuit description output step of the semiconductor integrated circuit high-level synthesis method of the first embodiment.

FIG. 11 is a flowchart illustrating a method for high-level synthesis of a semiconductor integrated circuit according to a second embodiment.

FIG. 12 is a diagram illustrating a DFG whose shape is changed in a circuit concealing step of the semiconductor integrated circuit high-level synthesis method of the second embodiment.

FIG. 13 is a diagram illustrating another DFG whose shape is changed in a circuit concealing step of the semiconductor integrated circuit high-level synthesis method of the second embodiment.

FIG. 14 is a flowchart illustrating a method for high-level synthesis of a semiconductor integrated circuit according to a third embodiment.

FIG. 15 is a diagram illustrating a DFG to which hardware resources have been allocated.

FIG. 16 is a diagram illustrating an RTL circuit structure inferred from the DFG of FIG. 15.

FIG. 17 is a diagram illustrating a DFG to which hardware resources have been allocated and whose shape has been changed in a circuit concealing step of the semiconductor integrated circuit high-level synthesis method of the third embodiment.

FIG. 18 is a diagram illustrating an RTL circuit structure inferred from the DFG of FIG. 17.

FIG. 19 is a flowchart illustrating a detail of a circuit concealing step of a method for high-level synthesis method of a semiconductor integrated circuit according to a fourth embodiment.

FIG. 20 is a diagram illustrating a DFG in which an addition operation is added in the circuit concealing step of the semiconductor integrated circuit high-level synthesis method of the fourth embodiment.

FIG. 21 is a diagram illustrating a DFG in which a multiplication operation is further added in the circuit concealing step of the semiconductor integrated circuit high-level synthesis method of the fourth embodiment.

### DETAILED DESCRIPTION OF THE PREFERRED EMBODIMENTS

Hereinafter, embodiments of the present invention will be described with reference to the accompanying drawings. Note that the present invention is not limited to the embodiments below. Various embodiments may be made without departing from the spirit or scope of the present invention.

### First Embodiment

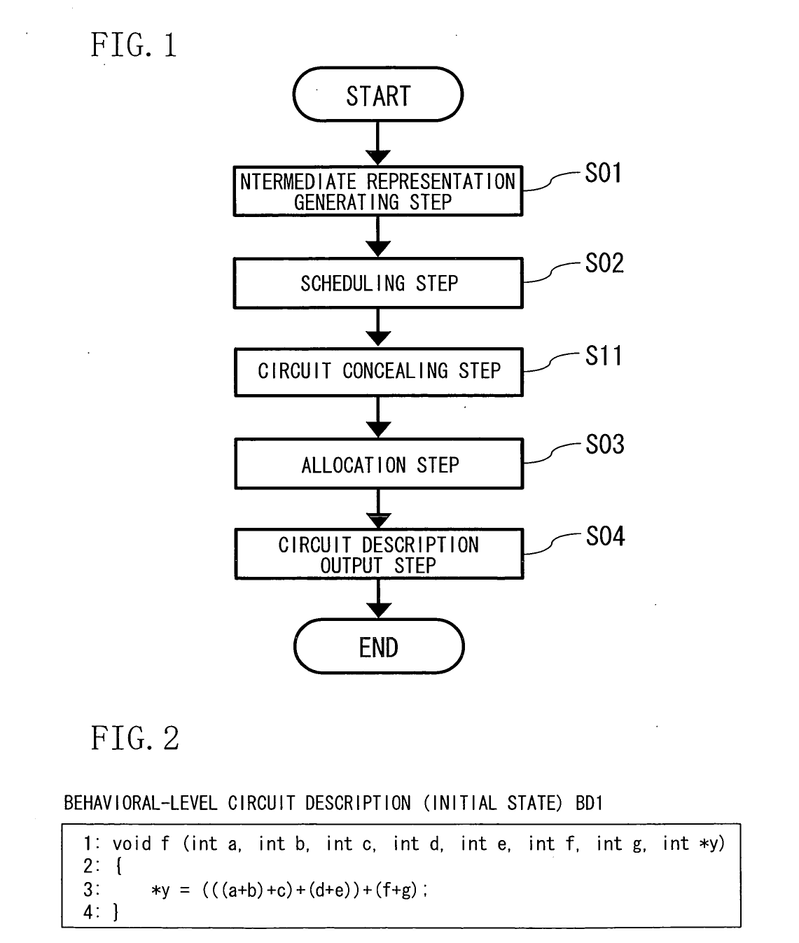

FIG. 1 is a flowchart illustrating a high-level synthesis method according to a first embodiment. In the high-level synthesis method of FIG. 1, an intermediate representation generating step S01, a scheduling step S02, a circuit concealing step S11, an allocation step S03, and a circuit description output step S04 are executed with respect to a behavioral-level circuit description of hardware. Initially, in the intermediate representation generating step S01, the behavioral-level circuit description of hardware is analyzed to generate a CDFG composed of a DFG representing a flow of operations and data appearing in the description and a CFG representing a flow of control of an execution sequence of the operations. Thereafter, in the scheduling step S02, an execution sequence of each node of the DFG generated in the intermediate representation generating step S01 is allocated to a time (state) which synchronizes with a clock, based on information about design constraints and available hardware resources for synthesis of desired hardware. Next, in the circuit concealing step S11, a lifetime of each node of the scheduled DFG generated in the scheduling step S02 is analyzed to change a shape of the DFG within a range in which a process cycle is not increased and without an influence on the result of execution of the DFG. Specifically, the shape of the DFG is changed by adding a redundant operation which guarantees the consistency of the output value of a node. A type and a method of an operation to be added are selected from those which are registered as a database, for example. Next, in the allocation step S03, a hardware resource which achieves a process is allocated to each node of the DFG whose shape has been changed in the circuit concealing step S11. In the circuit description output step S04, a circuit description at the behavioral level or in the RTL and information for decrypting concealed contents are output based on the results of the processes in the scheduling step S02, the circuit concealing step S11, and the allocation step S03.

Hereinafter, an exemplary computation of this embodiment will be described using a behavioral-level circuit description BD1 (before a concealment process: initial state) of FIG. 2 for the following calculation expression:

y=(((a+b)+c)+(d+e))+(f+g).

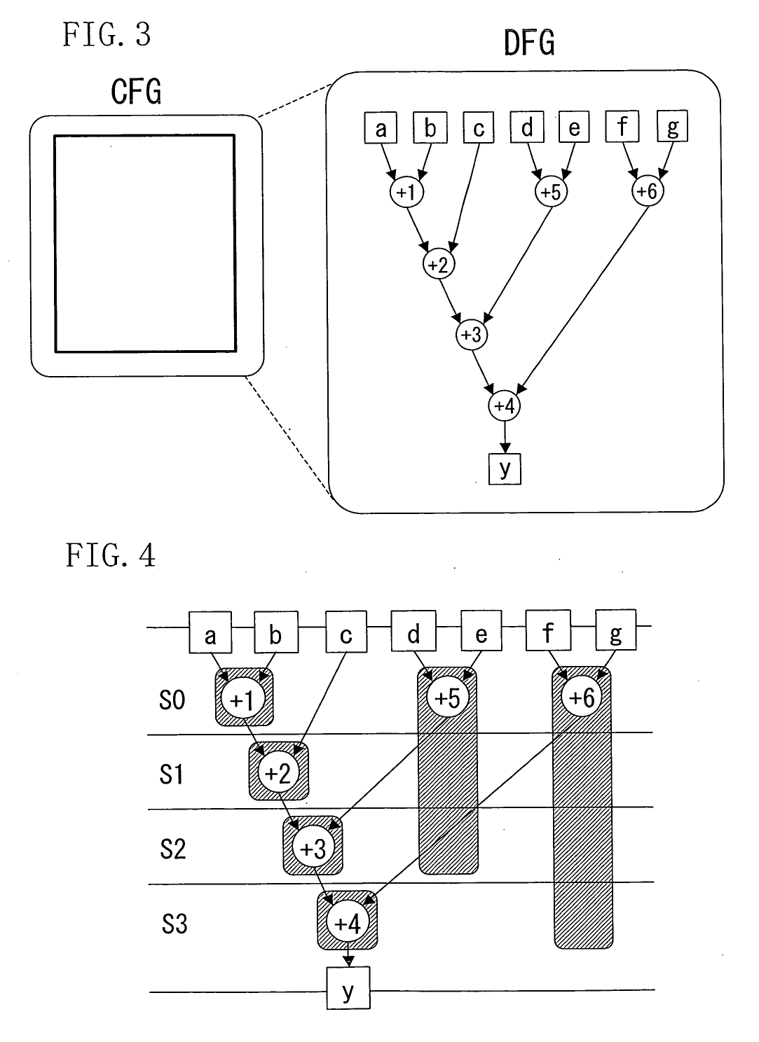

Initially, in the intermediate representation generating step S01, the behavioral-level circuit description BD1 is analyzed to generate a CDFG composed of a DFG in which variables and operations are represented by nodes and data flows are represented by edges, and a CFG in which the DFG is represented by a node and a control of an execution sequence of the DFG is represented by an edge. The CDFG of BD1 is represented by FIG. 3. In the BD1, there is not a conditional description (generally represented by an IF sentence, a FOR sentence or the like in a programming language, such as C/C++ or the like) for controlling the execution sequence of the process. Therefore, only one node is present on the CFG. Also, the nodes having the same allocated operation on the DFG are provided with identification numbers, such as +1, +2 and the like.

Next, in the scheduling step S02, each node of the DFG is allocated to a time (state) which synchronizes with a clock cycle to determine an execution sequence. FIG. 4 indicates the scheduled DFG of the BD1. Each node of the DFG is allocated to any of S0, S1, S2 and S3.

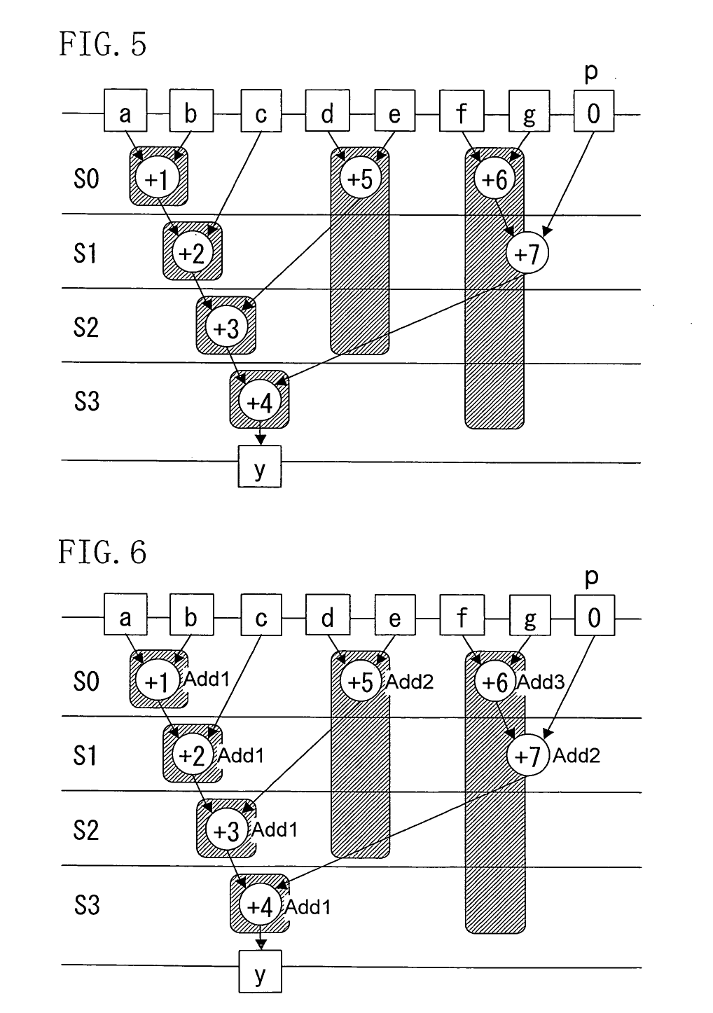

In the circuit concealing step S11, an operation is added within a range in which the number of process cycles is not increased and without an influence on the result of execution of the original behavioral-level circuit description BD1. To this end, initially, a lifetime of an output value of each node of the scheduled DFG is analyzed. The lifetime refers to the number of states in which the output value of a node is held. On the DFG of FIG. 4, the life times of the nodes +1, +2, +3 and +4 are 1, the lifetime of the node +5 is 3, and the lifetime of the node +6 is 4. The output value of the nodes having a lifetime of 2 or more (e.g., the output value of the node +6, etc.) is subjected to a new operation which guarantees the output value of the node +6. Operations to be newly added are assumed to include only operations to which a hardware resource which can be executed during one cycle is allocated. Thereby, the deterioration of circuit performance (the increase of the process cycle) due to addition of an operation is prevented. Also, as an operation which guarantees an output value, any operation may be selected from a database. However, here, a selection criterion that an operation is selected which is present on the DFG and is present in a state other than that to which the operation is added, is provided, and an addition of the output value of the node +6 and zero is added. FIG. 5 illustrates a DFG after the addition of the output value of the node +6 and zero is added. An addition node +7 and a constant node 0 are newly added. In this case, since five addition nodes +1, +3, +4, +5 and +6 are present in states on the DFG other than a state in which the addition node +7 is added, there is a possibility that hardware resources allocated to these addition nodes can be shared in the subsequent allocation step S03. When the hardware resources are shared, the increase in a circuit area due to the added operation can be suppressed by reducing the number of employed hardware resources.

Further, the constant node 0 which is to be an input of the addition node +7 is allocated to an input port p. A reason why a constant node is allocated to an input port is that, since an added operation is redundant, the redundancy is prevented from being removed in an optimization process during high-level synthesis or an optimization process during logic synthesis. The added operation is intended to make it difficult to decrypt a finally output circuit description. Therefore, the added operation needs to be reliably reflected on the output circuit description. Another reason is to conceal information required to correctly operate the circuit description. By concealing the constant value as an input port, even when the circuit description outflows, the circuit description cannot be correctly used unless a correct value is input to the input port, thereby making it possible to reduce a risk in case of outflow.

Next, in the allocation step S03, a hardware resource which executes a process is allocated to each node of the DFG whose shape has been changed in the circuit concealing step S11. FIG. 6 illustrates a DFG after the allocation of hardware resources. An addition resource Add2 which is allocated to the added node +7 is shared with the addition node +5, thereby making it possible to suppress the increase of the hardware resources.

Finally, in the circuit description output step S04, a circuit description on which the concealment process is reflected and concealment decryption information for decrypting concealed contents are output. The circuit designer manages the circuit description and the concealment decryption information separately, and provides the circuit description and the concealment decryption information via separate routes (e.g., electronic mail, a recording medium, etc.) to an authorized circuit description user, thereby making it possible to reduce the risk of decryption of design information when the circuit description outflows.

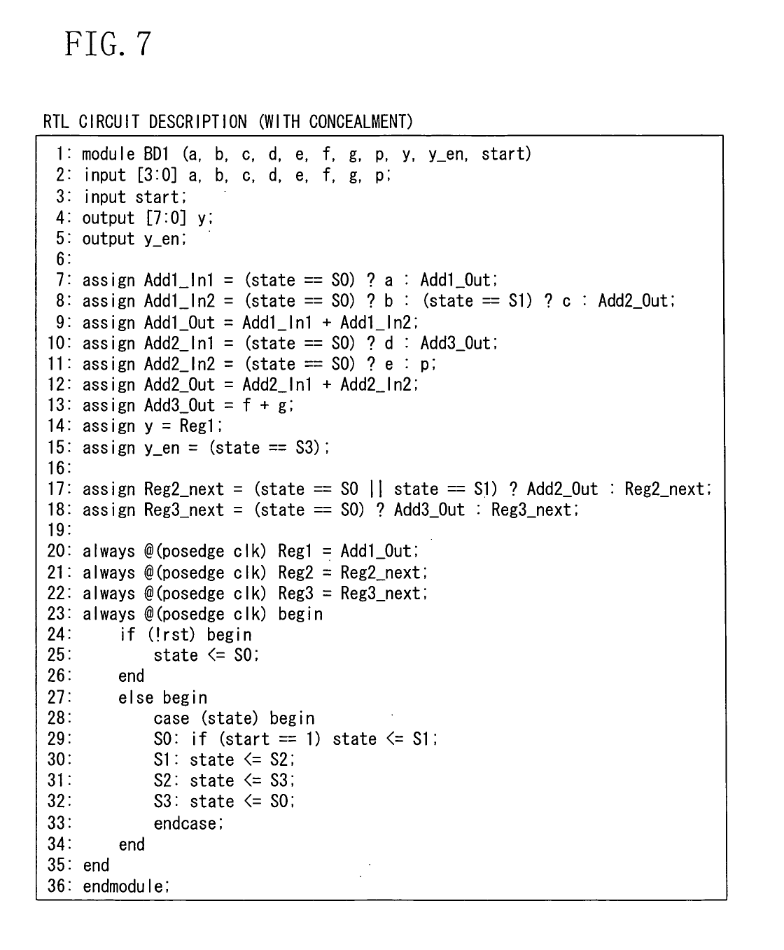

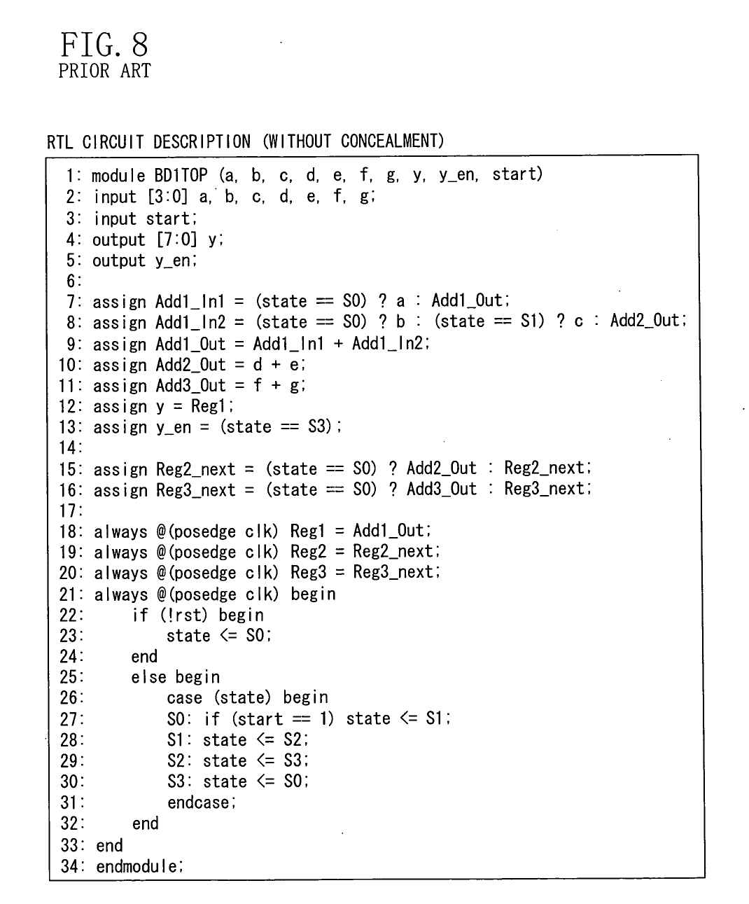

FIG. 7 illustrates an exemplary RTL circuit description obtained by high-level synthesis in which the behavioral-level circuit description BD1 is subjected to a concealment process. On the other hand, FIG. 8 illustrates an RTL circuit description obtained by conventional high-level synthesis without a concealment process. Note that the declaration of a wire and a register is not illustrated in both the RTL circuit descriptions. In both the RTL circuit descriptions, variable names in the BD1 are inherited by wire names, so that a description corresponding to a partial expression “d+e” of the BD1 remains, as it is in the BD1, on line 10 in the RTL circuit description of FIG. 8 in which a concealment process is not performed. On the other hand, in the RTL circuit description of FIG. 7, a description corresponding to “d+e” is provided in a form different from that of the BD1 (lines 10 to 12). Therefore, it is more difficult to decrypt the calculation expression of the BD1 from the RTL circuit description of FIG. 7 in which a concealment process is performed than from the RTL circuit description of FIG. 8. Also, in the case of RTL circuit description of FIG. 7, the same result which is obtained from the BD1 cannot be obtained unless zero is input to the input port p. Therefore, even when the RTL circuit description outflows, the risk of unauthorized use of the circuit description can be reduced.

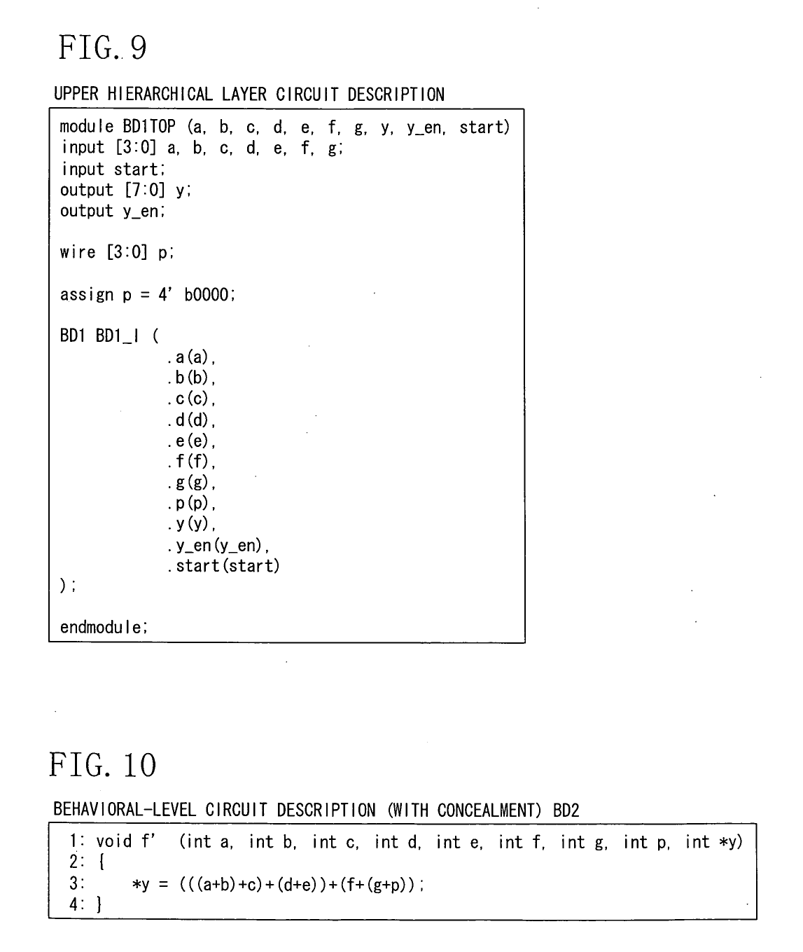

The concealment decryption information includes, for example, the number of added operations, the type of an added operation, the number of a line on which an added operation is present in a circuit description, a value to be input to an added operation (a value to be added to an added input port), and the like. A value to be input to an added operation may be provided as an upper hierarchical layer description with respect to a circuit description which has been subjected to a concealment process. FIG. 9 illustrates a circuit description which is present at an upper hierarchical layer with respect to the RTL circuit description of FIG. 7. The added input port p of FIG. 7 is fixed to zero. By obtaining the upper hierarchical layer description, the circuit description user can decrypt the concealed information.

Note that an output circuit description is not limited to an RTL circuit description, and may be a behavioral-level circuit description. FIG. 10 illustrates a behavioral-level circuit description BD2 which has been subjected to a concealment process. In BD2, an operation of a variable g and a variable p which is not present in the BD1 is added on the right side of line 3. It is difficult to derive the original BD1 from the BD2 unless necessary information, such as design information or the like, is known. Also, unless zero is input to the variable p, the same result which is obtained from the BD1 of FIG. 2 is not obtained. Thereby, the risk of decryption and unauthorized use of design information of the behavioral-level circuit description can be reduced.

Also, an assertion description for confirming that results before and after an added operation are the same may be added to a circuit description. When a large number of input ports are added, a lot of time and effort are required to confirm whether correct values have been set into all of these input ports. Therefore, when the circuit designer makes a mistake in setting of a value into an added input port during debugging, the mistake can be automatically detected, so that the risk of occurrence of a step of analyzing a problem which may occur due to concealment of design information can be reduced.

As described above, a circuit description in which design information is concealed (concealment of design information and difficult decryption of design data) can be generated. Also, since an added operation is provided with respect to an output value of a node having a lifetime of 2 or more, a scheduling result does not need to be changed due to the added operation, so that circuit performance is not deteriorated.

Although an added operation is an addition with zero in this embodiment, the added operation may be any type of operation which is present in a database and can guarantee an output value, such as a selection operation, a comparison operation, a logic operation, four basic operations other than addition, or the like.

Also, although an addition operation present on the DFG is selected as an added operation in this embodiment, an operation which is not present on the DFG may be conversely added as a selection criterion for an added operation. In the example of FIG. 3, for example, a multiplication of the output value of the node +6 and a constant 1, a selection operation (a select signal is input through an input port) in which one of the output value of the node +6 and a constant 0 is selected, or the like may be added instead of an addition operation. In this case, since it cannot be expected that hardware resources are shared in the subsequent allocation step S03, the suppression of the circuit area cannot be expected. However, an operation which is not present on the DFG is not present in a circuit specification in which an algorithm and the like are described. Therefore, it is difficult to infer the algorithm from arithmetic operators in an output circuit description, thereby making it possible to reduce the risk of unauthorized decryption when the circuit description outflows.

Also, although an operation is added to only one node in the circuit concealing step S11 in this embodiment, an operation may be added to a plurality of nodes having a lifetime of 2 or more.

Also, although a constant node which is to be an input of an added operation (addition node +7) is allocated to an input port (p) in this embodiment, a constant node which is present on an original DFG before an operation is added may be allocated to an input port, since the concealment of a constant has an effect of concealing information for correctly operating a circuit regardless of whether or not the constant is related to an added operation.

### Second Embodiment

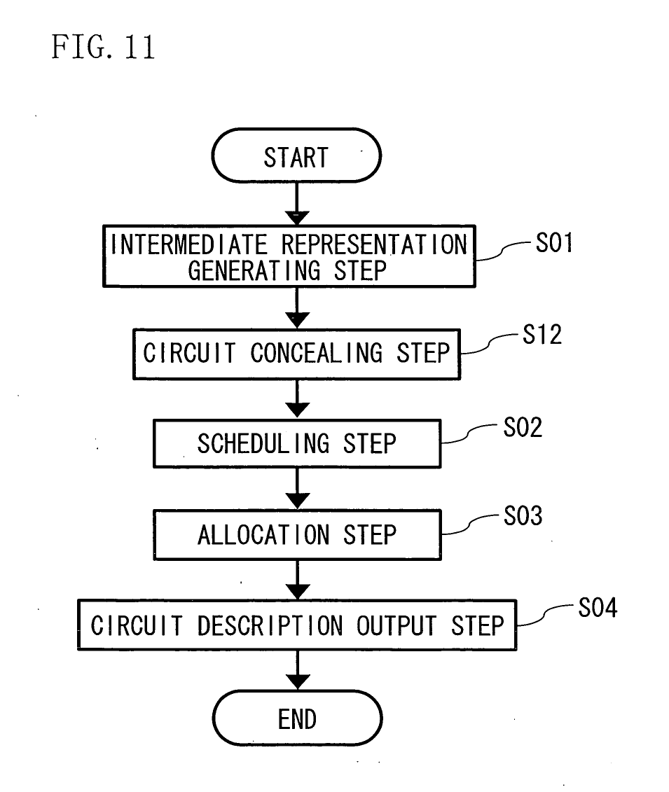

FIG. 11 is a flowchart illustrating a high-level synthesis method according to a second embodiment. The high-level synthesis method of the second embodiment is different from that of the first embodiment in that a concealment process for a circuit is performed before the scheduling step S02. A circuit concealing step S12 of FIG. 11 is free from the constraint of the scheduling result during circuit concealment, so that an operation can be added more flexibly than in the first embodiment.

An operation may be added to a node present on a shortest-delay path on a DFG. Initially, for each node on a DFG, a delay on a path which passes through the node is calculated, and a longest delay is set.

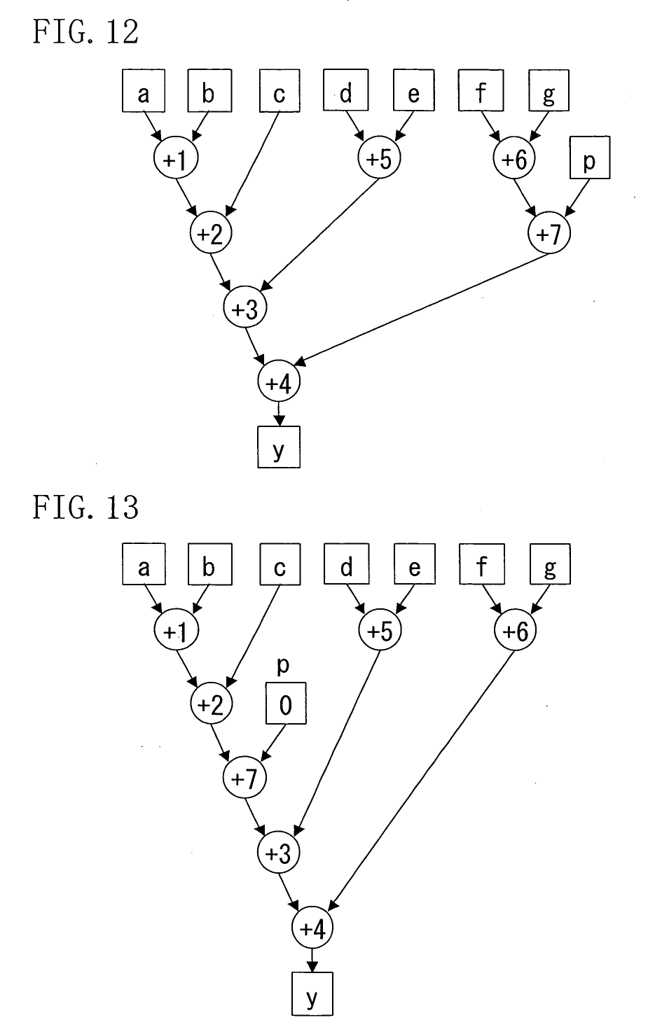

A description will be given using the DFG of FIG. 3 obtained from the BD1. Here, it is assumed that the addition node has a delay of 10 ns, and the input node and the output node both have a delay of 0 ns. There are two paths which pass through the node +1: (a, +1, +2, +3, +4); and (b, +1, +2, +3, +4). These two paths both have a delay of 40 ns, so that 40 ns is set into the node +1. There are three paths which pass through the node +2: (a, +1, +2, +3, +4); (b, +1, +2, +3, +4); and (c, +2, +3, +4). These three paths have delays of 40 ns, 40 ns and 30 ns, respectively. Based on the longest delay, 40 ns is set into the node +2. By performing similar calculations, 40 ns, 40 ns, 30 ns and 20 ns are set into the nodes +3, +4, +5 and +6, respectively. Since a node present on the shortest-delay path is +6, the output value of the node +6 is here subjected to a new operation. For example, if an addition with zero is added, a DFG of FIG. 12 is obtained. In this case, (f, +6, +7, +4) and (g, +6, +7, +4) are longest-delay paths which pass through the added operation +7 (delay: 30 ns). Therefore, the longest delay of the original DFG of FIG. 3 does not exceed 40 ns, so that the increase of a process cycle can be prevented in the result of the subsequent scheduling step S02.

As described above, an operation is added to a node present on a shortest-delay path of a DFG, thereby making it possible to achieve circuit concealment in which the increase of the process cycle is reduced in the scheduling step S02. Also, an operation is added to a DFG before scheduling, thereby making it possible to perform scheduling in the scheduling step S02 in view of sharing of a hardware resource, including an added operation (node) as well as nodes on an original DFG, as is different from the first embodiment.

Conversely, an operation may be added to a node present on a longest-delay path of a DFG. In this case, since the process cycle is highly likely to increase in the scheduling step S02, only a behavioral-level circuit description is output in the circuit description output step S04. A reason why an RTL circuit description is not output is that it is difficult to improve the process cycle in a logic synthesis step and later. On the other hand, a behavioral-level circuit description which has been subjected to a concealment process is subjected again to conventional high-level synthesis without a concealment process, thereby making it possible to improve the process cycle.

For example, as illustrated in FIG. 13, the output of the operation node +2 of FIG. 3 is subjected to a redundant addition operation with zero, and a constant value is concealed as an input port. An behavioral-level circuit description output after this treatment is subjected to conventional high-level synthesis. Assuming that an addition node has a delay of 10 ns, (a, +1, +2, +7, +3, +4) or (b, +1, +2, +7, +3, +4) of paths which pass through the added operation (node) +7 has a longest delay of 50 ns, which exceeds a longest delay of 40 ns of the original behavioral-level circuit description. Therefore, there is a possibility that the number of cycles is increased due to a constraint on a clock frequency. However, as described in the first embodiment, when high-level synthesis is performed with respect to a behavioral-level upper hierarchical layer description in which a correct constant value is set into an added port and which is output as concealment decryption information, an added operation, which is inherently redundant, is calculated at the DFG level by an optimization function (specifically, a constant propagation function) of the high-level synthesis. A DFG from which an added operation (redundant operation) after constant propagation is removed, is basically the same as an initial DFG before the operation is added, i.e., the DFG of FIG. 3. The result of scheduling performed with respect to this DFG does not include a redundant cycle. This can be achieved by obtaining concealment decryption information, thereby making it possible to reduce the risk of generation of an authorized RTL circuit description which does not include an unnecessary cycle for concealment of design information, from a concealed behavioral-level circuit description. Also, if a behavioral-level circuit description in which an excessively large number of operations are added is subjected to high-level synthesis without providing concealment decryption information and with an added port being described as it is a port, there is a possibility that the cycle is unnecessarily increased due to the added operations as described above. As a result, the number of process cycles when the circuit description is operated differs from the original performance of the algorithm, thereby making it difficult to infer the algorithm from the process cycle.

Thus, by performing a concealment process of design information before scheduling, the increase of the area of a hardware resource for performing an added operation can be suppressed while suppressing the deterioration of the circuit performance (process cycle). Also, a behavioral-level circuit description obtained by concealing design information before scheduling can conceal design information and make it difficult to decrypt a circuit description, and can also conceal the performance (process cycle) of an output RTL circuit description, thereby making it possible to improve the degree of concealment of design information.

### Third Embodiment

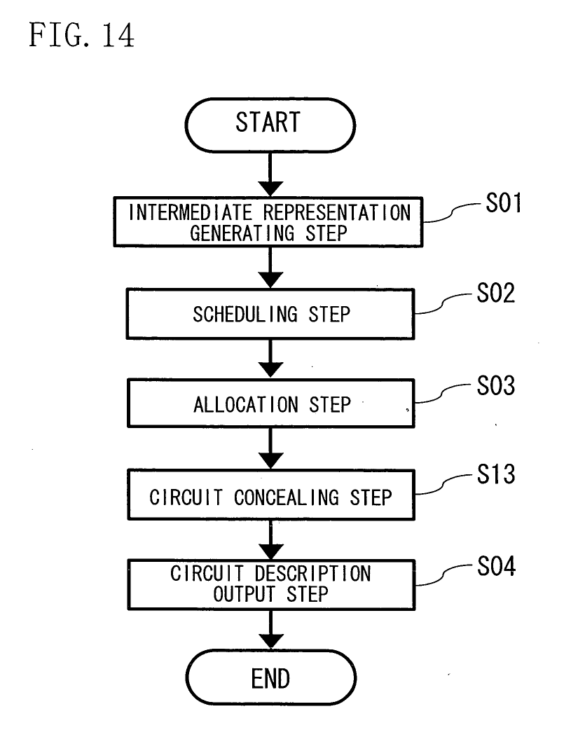

FIG. 14 is a flowchart illustrating a high-level synthesis method according to a third embodiment. The high-level synthesis method of the third embodiment is different from that of the first embodiment in that a circuit concealment process is performed after the allocation step S03. Here, it is assumed that a redundant calculation expression present in an input behavioral-level circuit description is removed by an optimization function when a CDFG is generated in the intermediate representation generating step S01.

In a circuit concealing step S13 of FIG. 14, an operation can be added while inferring an RTL circuit structure from allocation information during circuit concealment.

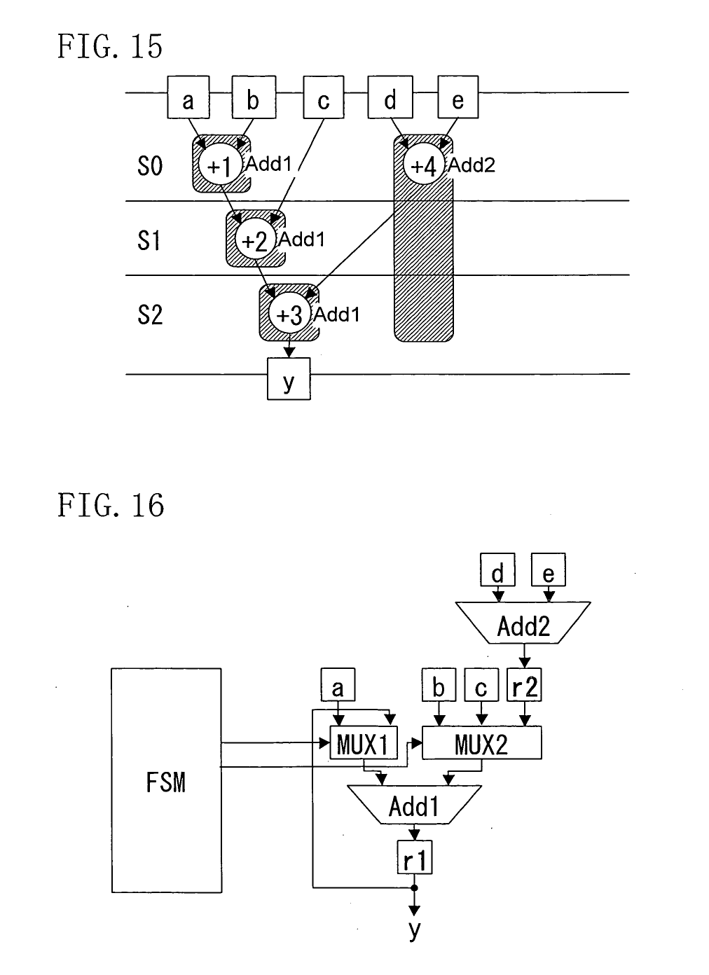

A description will be given using a DFG after allocation of FIG. 15. Note that outputs of hardware resources Add1 and Add2 are received by registers R1 and R2, respectively. Based on the allocation result of FIG. 15, an RTL circuit structure illustrated in FIG. 16 can be inferred.

Initially, a node whose output value has a lifetime of 2 or more is selected. Here, only the output of a node +4 has a lifetime of 2 or more. A new operation which is performed with respect to the output of the selected node is selected from a database. In this case, it is assumed that the selected operation can be executed by reusing a hardware resource allocated to a node on the DFG of FIG. 15 without changing scheduling. In the example of FIG. 15, only the hardware resource Add2 allocated to the node +4 can be reused in states S1 and S2. Therefore, an addition with zero which is performed in the state S1 is added as an operation executable in Add2 to the output of the node +4.

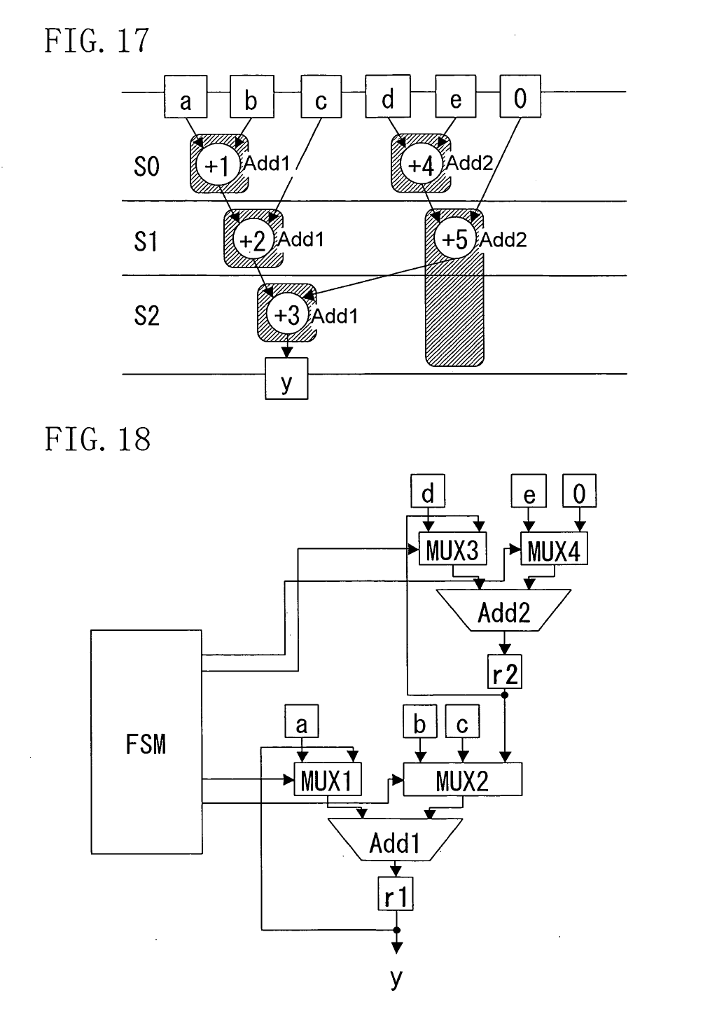

Note that a constant which is to be an input to the added operation is not allocated to an input port. A DFG after this treatment is illustrated in FIG. 17. Based on the allocation result of FIG. 17, an RTL circuit structure illustrated in FIG. 18 can be inferred. Here, the reused hardware resource performs two or more operations, so that an input control for appropriately performing these operations is required. In FIG. 18, by controlling (selecting) inputs using multiplexers MUX3 and MUX4, an original operation and a redundant operation are performed as appropriate.

The circuit description output step S04 outputs a circuit structure which is inferred based on a DFG whose shape is finally changed in the circuit concealing step S13 and allocation information, as an RTL circuit description. The RTL circuit description includes a redundantly added operation and control, and therefore, is a complicated description which is difficult to decrypt.

Thus, by analyzing a DFG to which a hardware resource is allocated to perform a circuit concealment process, a redundant operation and control which provide difficult decryption can be created, thereby making it possible to reduce the risk of decryption of a circuit description when design data outflows. Also, by creating a redundant operation on the assumption that a hardware resource is reused, the increase of hardware resources can be suppressed. Also, as is different from the first embodiment, a port for concealing design information is not added, so that a special care is not required when a circuit description is verified.

In the high-level synthesis method of this embodiment, only an RTL circuit description is output in the circuit description output step S04 so as to make it difficult to decrypt an RTL circuit structure.

Note that, when there are a plurality of options for an operation (node) to which a redundant operation is performed, one for which a multiplexer which selects an input of a reused hardware resource has a small number of inputs (or stages) may be selected. A control signal for selecting an output of a multiplexer is generated from outputs of a state register of a Finite State Machine (FSM) which is a control circuit, and a data path circuit. When a control becomes complicated as the number of selected inputs increases, the number of logic stages for generating a control signal is highly likely to increase. In this case, a delay on a path from the state register via the multiplexer to the register of the data path circuit may not satisfy an operating frequency constraint defined in design constraints. Therefore, the risk of delay violation can be suppressed by employing a hardware resource in which the number of inputs of a multiplexer is small.

Also, as a hardware resource to be reused, one having a small bit width may be selected. Note that the hardware resource is assumed to have a bit width which allows a selected operation to be sufficiently performed. A multiplexer to be added so as to select an input depends on the input bit width of the hardware resource. Therefore, by selecting a hardware resource having a small bit width, the bit width of the multiplexer is reduced, thereby making it possible to suppress the increase of the area.

### Fourth Embodiment

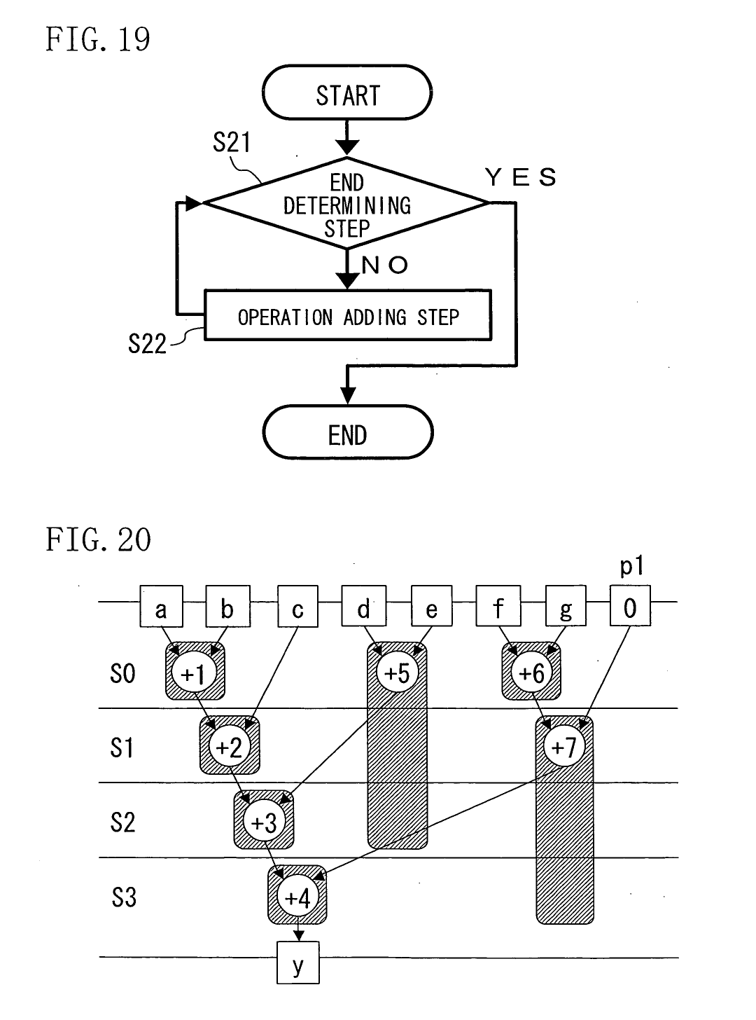

FIG. 19 is a flowchart illustrating a circuit concealing step in a high-level synthesis method according to a fourth embodiment. In this embodiment, the number of operations added in the circuit concealing steps S11, S12 and S13 in the first to third embodiments is limited in accordance with a predetermined criterion.

In the circuit concealing step of this embodiment, as illustrated in FIG. 19, an end determining step S21 is performed before an operation adding step S22. In the end determining step S21, it is determined whether the process is ended or continued, in accordance with the predetermined criterion. When it is determined that the process is continued (NO), the operation adding step S22 is performed. After the end of the operation adding step S22, the process returns to the end determining step S21. Until it is determined that the process is ended (YES) or until an operation cannot be added, the operation adding step S22 and the end determining step S21 are repeatedly performed.

Hereinafter, an exemplary computation of this embodiment will be described using the DFG of FIG. 4 obtained from the behavioral-level circuit description BD1.

Firstly, a method in which the number of operations is limited as a criterion for ending a process will be described. Here, it is assumed that the number of added operations is “2 or less”.

According to FIG. 19, initially, in the end determining step S21, it is determined whether or not the number of added operations reaches the predetermined criterion (2 or less). Since the number of added operation is 0, the process goes to the operation adding step S22. In the operation adding step S22, a node having lifetime of 2 or more is selected, and a new operation is added with respect to an output of the node.

For example, a node having a small bit width may be selected. The area of a hardware resource which executes an added operation increases with an increase in a bit width to be calculated. When a 32-bit operation is added, a 32-bit addition resource is required. When a 4-bit operation is added, a 4-bit addition resource is required. Therefore, when a node having a small bit width is selected, there is a possibility that the area of a hardware resource which executes an added operation can be reduced.

Alternatively, a constant node may be selected. A constant node present on a DFG may be a constant defined in an algorithm. In this case, by creating a constant defined in an algorithm using an operation with another constant, the constant defined in the algorithm can be concealed from a finally output circuit description. As a result, the risk of decryption of an algorithm from a constant in a circuit description can be reduced.

In the example of FIG. 4, the node +6 is selected. The output value of the node +6 is subjected to an addition with zero, thereby guaranteeing the output value of the node +6. As illustrated in FIG. 20, a DFG to which the addition with zero is added is the same as that of the first embodiment of FIG. 5.

Next, the process returns to the end determining step S21. Here, the number of added operations is one, i.e., does not reach the predetermined criterion (2 or less), the process goes to the operation adding step S22 again.

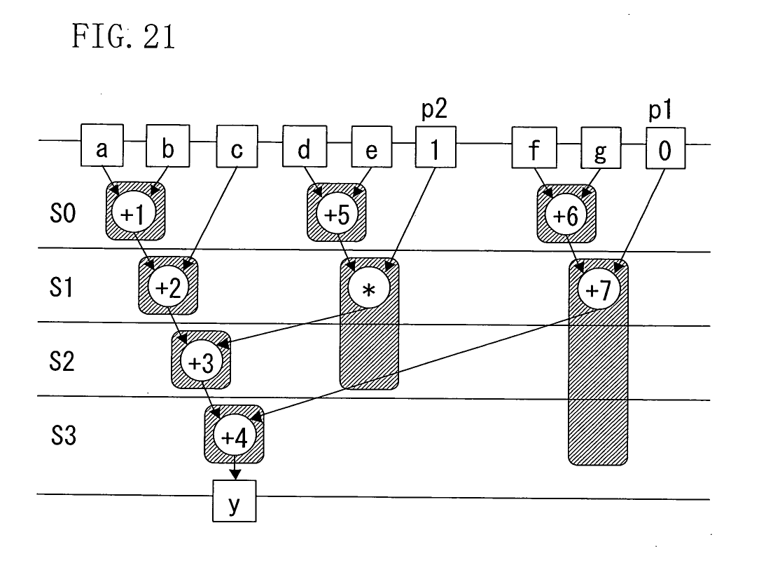

In the operation adding step S22, a node is selected based on lifetime information of an updated DFG. FIG. 20 illustrates a DFG after being updated by a first execution of the operation adding step S22, and lifetimes. The nodes +5 and +7 each have a lifetime of 2 or more. Here, the output value of the node +5 is subjected to a new operation. FIG. 21 illustrates a DFG after the output value of the node +5 is subjected to a multiplication by 1, and lifetime information.

The process goes to the end determining step S21 again. In the updated DFG (see FIG. 21), two nodes having a lifetime of 2 or more (*, +7) are present. Since the number of added operations is two, i.e., reaches the predetermined criterion (2 or less), the process is here ended.

Next, a method in which the number of added operations is limited by an increase rate of the circuit area as a criterion for ending the process, will be described. Here, the criterion is assumed to be that the process is continued until the increase rate of the circuit area exceeds 10%. Also, it is assumed that all addition resources have the same area of 10.

Initially, in the end determining step S21, it is determined whether or not the number of added operations exceeds the predetermined criterion (circuit area increase rate: 10%). The original circuit area of the DFG of FIG. 4 is estimated to be 60 since there are six addition operations. Here, the number of added operations is zero, so that the area increase rate is zero, and therefore, the process goes to the operation adding step S22.

In the operation adding step S22, a node having a lifetime of 2 or more is selected, and a new operation is added to an output of the node. Here, the node +6 is selected, and an addition with zero is added. The DFG in which the addition with zero is added, is illustrated in FIG. 20. Since an addition operation is added, the circuit area is estimated to be 70.

Next, the process goes to the end determining step S21. Since the circuit area is increased from 60 (original estimated value) to 70, the increase rate is 16%. Since the increase rate exceeds the predetermined criterion (circuit area increase rate: 10%), the process is here ended.

In this manner, the number of added operations can be controlled in accordance with the predetermined criterion. When the number of added operations is limited, the amount of information for concealing design information can be mainly controlled. Also, when the circuit area increase rate is limited, the overhead of the circuit area can be suppressed while concealing design information.

Note that the increase rate of circuit performance (longest path delay) may be limited instead of the circuit area increase rate. For example, as illustrated in the second embodiment of FIG. 11, when an operation is added to a DFG generated in the intermediate representation generating step S01, it is possible to prevent the process cycle from being increased as a result of scheduling due to an excessive increase in the longest path delay, while concealing design information.

As has been heretofore described above, the high-level synthesis method for a semiconductor integrated circuit according to the present invention has the effect of reducing the risk of unauthorized use and decryption when a circuit description outflows, and is useful for, for example, generation of an RTL circuit description for constructing a digital circuit.

What is claimed is:

1. A method for high-level synthesis of a semiconductor integrated circuit, comprising:
an intermediate representation generating step of analyzing a circuit description at a behavioral level of hardware to generate a Control Data Flow Graph (CDFG) composed of a Data Flow Graph (DFG) representing a flow of an operation and data appearing in the description and a Control Flow Graph (CFG) representing a flow of control of an execution sequence of the operation;
a scheduling step of allocating an execution sequence of each node of the CDFG to a state synchronizing with a clock, based on information about a design constraint of a desired hardware circuit and an available hardware resource;
an allocation step of allocating a hardware resource for achieving a process to each node of the CDFG;
a circuit concealing step of changing the CDFG or a result of the allocation in view of concealment of design information in an output circuit description; and
a circuit description output step of outputting a circuit description and concealment decryption information based on a process result of each step.

2. The method of claim 1, wherein the changing of the CDFG in the circuit concealing step is to add an operation which guarantees the consistency of a process result, and the operation is an operation which is not present on the CDFG.

3. The method of claim 1, wherein the changing of the CDFG in the circuit concealing step is to add an operation which guarantees the consistency of a process result, and the operation is an operation which is present on the CDFG.

4. The method of claim 1, wherein the changing of the CDFG in the circuit concealing step is to add an operation which guarantees the consistency of a process result, and delays on paths between an input and an output of the CDFG generated in the intermediate representation generating step are analyzed, and the operation is added to a path having a short delay with priority.

5. The method of claim 1, wherein the changing of the CDFG in the circuit concealing step is to add an operation which guarantees the consistency of a process result, and delays on paths between an input and an output of the CDFG generated in the intermediate representation generating step are analyzed, and the operation is added to a path having a long delay with priority.

6. The method of claim 1, wherein the changing of the CDFG in the circuit concealing step is to add an operation which guarantees the consistency of a process result, and the scheduled CDFG generated in the scheduling step is analyzed, and the operation is added within a range in which a process cycle is not increased.

7. The method of claim 1, wherein the circuit concealing step includes allocating a node representing a constant of the changed CDFG to a hardware resource other than constants.

8. The method of claim 7, wherein the hardware resource other than constants is an input port.

9. The method of claim 1, wherein the circuit concealing step includes adding an operation to a node having a small input bit width of the CDFG, the operation creating an output value of the node.

10. The method of claim 1, wherein the circuit concealing step includes adding an operation to a constant node of the CDFG, the operation creating a constant value of the constant node.

11. The method of claim 1, wherein the changing of the CDFG in the circuit concealing step is to add an operation which guarantees the consistency of a process result, and the operation is created by reusing the hardware resource allocated in the allocation step.

12. The method of claim 11, wherein the circuit concealing step includes reusing a hardware resource in which a multiplexer for selecting an input has a small control delay, with priority.

13. The method of claim 11, wherein the circuit concealing step including reusing a hardware resource having a small input bit width with priority.

14. The method of claim 1, wherein the circuit concealing step including limiting the number of operations added in the CDFG in accordance with a predetermined criterion.

15. The method of claim 14, wherein the predetermined criterion is an upper limit of the number of added operations.

16. The method of claim 14, wherein the predetermined criterion is an upper limit of an area increase rate at which an area of a hardware resource required to execute the added operation increases a circuit area before performing the circuit concealing step.

17. The method of claim 14, wherein the predetermined criterion is a delay increase rate at which a delay required to execute the added operation increases a longest path of the CDFG.

18. The method of claim 1, wherein the circuit description output step includes outputting the circuit description which includes an assertion description for verifying whether or not a result of the added operation has a desired value.

19. The method of claim 1, wherein the circuit description output step includes outputting the circuit description at a behavioral level.

20. The method of claim 1, wherein the circuit description output step includes outputting the circuit description at a register transfer level.

21. The method of claim 1, wherein the circuit description output step includes outputting a circuit description in an upper hierarchical layer for decrypting the output circuit description as a separate file of concealment decryption information.

22. The method of claim 1, wherein a method for the added operation is provided as a database.
